(19) United States
(12) Patent Application Publication
(10) Pub. No.: US 2024/0166224 A1
(43) Pub. Date: May 23, 2024

(54) VEHICLE CONTROLLER

(71) Applicant: TOYOTA JIDOSHA KABUSHIKI KAISHA, Toyota-shi Aichi-ken (JP)

(72) Inventors: Kotoru SATO, Hadano-shi Kanagawa (JP); Shigeki Nakayama, Gotenba-shi Shizuoka (JP); Tomohiro Kaneko, Mishima-shi Shizuoka (JP)

(73) Assignee: TOYOTA JIDOSHA KABUSHIKI KAISHA, Toyota-shi Aichi-ken (JP)

(21) Appl. No.: 18/371,482

(22) Filed: Sep. 22, 2023

(30) Foreign Application Priority Data
Nov. 17, 2022 (JP) 2022-184485

(51) Int. Cl. B60W 50/08; B60W 40/08

(52) U.S. Cl. CPC B60W 50/087; B60W 40/08; B60W 2540/229

(57) ABSTRACT

A vehicle controller includes a processer configured to estimate emotion of a driver based on biological information thereof; and determine an intervention amount of a driving assistance function based on the estimation result.

### CROSS-REFERENCE TO RELATED APPLICATION(S)

The present application claims priority to and incorporates by reference the entire contents of Japanese Patent Application No. 2022-184485 filed in Japan on Nov. 17, 2022.

### BACKGROUND

The present disclosure relates to a vehicle controller.

Japanese Laid-open Patent Publication No. H09-222922 discloses a vehicle control device switchable between automatic operation (autonomous running) and manual operation.

### SUMMARY

There is a need for providing a vehicle controller that can adjust the amount of intervention of the driving assistance function to a value suitable for the driver.

According to an embodiment, a vehicle controller includes a processer that estimates emotion of a driver based on biological information thereof; and determines an intervention amount of a driving assistance function based on the estimation result.

### BRIEF DESCRIPTION OF THE DRAWINGS

FIG. 1 is a schematic configuration diagram of a vehicle including a vehicle control apparatus according to the embodiment; and

FIG. 2 is a flowchart illustrating an outline of a process that the vehicle control device executes.

### DETAILED DESCRIPTION

It is desirable that the intervention amount of driving assistance functions such as power steering is adjusted to a value suitable for the driver.

A vehicle control apparatus according to an embodiment of the present disclosure will be described with reference to the drawings. In addition, components in the following embodiments include those which can be substituted and easily by those skilled in the art, or those which are substantially the same.

Configuration of the Vehicle

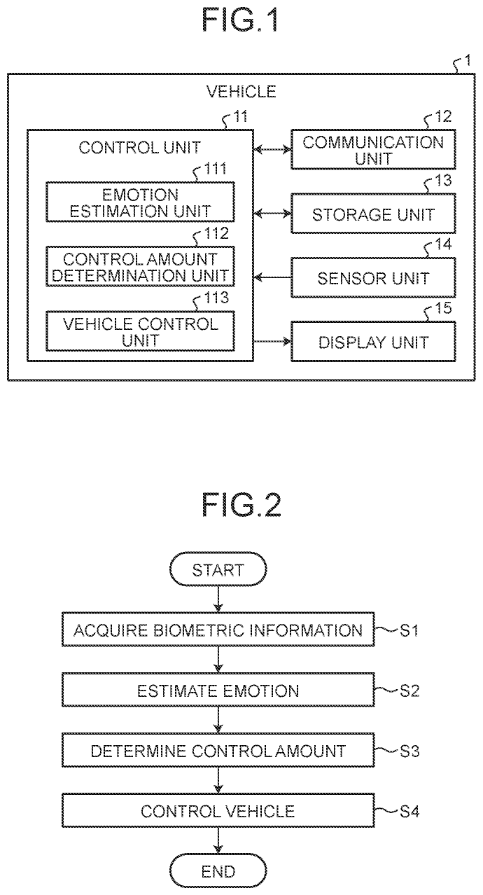

FIG. 1 is a schematic configuration diagram of a vehicle including a vehicle control apparatus according to the embodiment. A vehicle 1 illustrated in FIG. 1 is, for example, an engine-powered vehicle, a hybrid vehicle (Hybrid Electric Vehicle: HEV), a plying hybrid vehicle (Plug-in Hybrid Electric Vehicle: PHEV), a fuel-cell vehicle (Fuel Cell Electric Vehicle: FCEV), an electric vehicle (Battery Electric Vehicle: BEV) and the like. Further, the vehicle 1 is provided with a driving assistance function for assisting the operation of the driver such as handling, braking, or accelerator. As driving assistance functions, specifically, assistance of a force necessary for handling (power steering), assistance of a steering amount of a steering wheel, and assistance of an operation amount of an accelerator or a brake are mentioned. Further, the driving assistance function may include the assistance of setting the suspension, the assistance of setting the driving position, the assistance of setting the speed of the wiper, the assistance of the automatic setting of the air conditioner, and the like.

The vehicle 1 includes a control unit 11 serving as a vehicle control device, a communication unit 12, a storage unit 13, a sensor unit 14, and a display unit 15.

Specifically, the control unit 11 is an electronic control unit (Electronic Control Unit: ECU) having a microcomputer composed of a Central Processing Unit (CPU), a Read Only Memory (ROM), a Random Access Memory (RAM), and the like as main components, and executes various programs. The control unit 11 comprehensively controls the operation of various components mounted in the vehicle 1 by executing various programs. The control unit 11 functions as an emotion estimation unit 111, a control amount determination unit 112, and a vehicle control unit 113 through execution of various programs.

The emotion estimation unit 111 estimates the emotion of the driver based on the biological information. Specifically, the emotion estimation unit 111 estimates whether or not the emotion of the driver is comfortable based on the biological information. The biological information is, for example, an image of a driver captured by the camera of the sensor unit 14, but may be CO2 density of exhaled air of the driver measured by CO2 sensor of the sensor unit 14 or the heart rate of the driver acquired by the communication unit 12 from the wearable terminal worn by the driver or the like.

The emotion estimation unit 111 may perform emotion estimation on the basis of the learned model previously learned by the machine learning. When using the learned model, the input data is biometric information of the driver, for example an imaging signal obtained by imaging the driver. The output data is, for example, a numerical value representing the probability that the driver's emotion is comfortable or uncomfortable. The method of constructing the learned model used in the emotion estimation unit 111 is not particularly limited, and various machine learning methods such as deep learning using a neural network, a support vector machine, a decision tree, a simple Bayesian, and a k-neighborhood method may be used.

The control amount determination unit 112 determines the intervention amount of the driving assistance function based on the estimation result of the emotion estimation unit 111. Specifically, when the emotion estimation unit 111 estimates that the emotion of the driver is comfortable, the control amount determination unit 112 increases the intervention amount of the driving assistance function.

The vehicle control unit 113 controls the operation of the vehicle 1 according to the intervention amount determined by the control amount determination unit 112.

The communication unit 12 is constituted by a communication module or the like capable of transmitting and receiving various information, for example.

The communication unit 12 transmits and receives various types of information by, for example, connecting to a wired or wireless network and communicating with various terminals such as a personal computer, a smartphone, or a wearable terminal worn by a driver.

The storage unit 13 is composed of a EPROM (Erasable Programmable ROM, a hard disk drive (Hard Disk Drive: HDD), and a recording medium such as a removable medium. Removable media includes disc recording media such as, for example, a Universal Serial Bus (USB) memory, a Compact Disc (CD), a Digital Versatile Disc (DVD), and a Blu-ray Disk (BD) (registered trademark). The storage unit 13 can store an operating system (Operating System: OS), various programs, various tables, various databases, etc. In addition, the storage unit 13 may store the estimation result in the emotion estimation unit 111, for example, or the intervention amount determined by the control amount determination unit 112. In addition, a model (a learned model) used in the emotion estimation unit 311 that has already been machine learning, or the like may be stored in the storage unit 13.

The sensor unit 14 is for acquiring biological information. The sensor unit 14 includes, for example, various sensors such as a camera that captures an image of a driver, a CO2 sensor that measures CO2 density of exhaled air by the driver, and the like.

A display unit (display) 15 is for outputting a predetermined information to the user of the vehicle 1 (e.g., a driver). The display unit 15 is provided in the vehicle interior at a position visible to the user. The display unit 15 is realized by a car navigation device, a multi-information display, a head-up display, or the like.

### Processing of the Vehicle Controller

Next, the process of the control unit 11 executes. Here, the case where the assistance of the force necessary for the handling is performed by the power steering as the driving assistance function will be described. FIG. 2 is a flowchart illustrating an outline of a process that the vehicle control device executes.

When the driver operates the steering wheel while the vehicle 1 is running, the power steering assists the steerings wheel with a predetermined amount of intervention. At this time, the communication unit 12 acquires the biometric information of the driver (step S1).

Specifically, the communication unit 12, the camera receives an imaging signal obtained by imaging the driver as biometric information of the driver from the sensor unit 14.

Subsequently, the emotion estimation unit 111 estimates the emotion of the drivers (step S2). Specifically, the emotion estimation unit 111 analyzes the imaging signal received by the communication unit 12 and estimates whether or not the emotion of the driver is comfortable.

Thereafter, the control amount determination unit 112 determines the control amount of the operation assist function (step S3). Specifically, when the emotion estimation unit 111 estimates that the emotion of the driver is comfortable, the control amount determination unit 112 determines to increase the intervention amount of the power steering, which is a driving assistance function, from the predetermined value. On the other hand, when the emotion estimation unit 111 estimates that the emotion of the driver is uncomfortable, the control amount determination unit 112 determines to reduce the intervention amount of the power steering, which is a driving assistance function, from the predetermined value.

Then, the vehicle control unit 113 controls the vehicle 1 using the intervention amount determined by the control amount determination unit 112 (step 34).

By repeatedly executing steps S1˜S4 described above, the intervention amount of the power steering, which is a driving assistance function, can be made close to the value that the driver feels more comfortable. Therefore, the control unit 11 is a vehicle control device capable of adjusting the intervention amount of the driving assist function to a value suitable for the driver. Further, the control unit 11, since the camera uses the imaging signal captured, it is not necessary to prepare a large amount of parameters in advance, it is possible to optimize the intervention amount of the driving assist function without labor.

Although it may continue to execute the process of steps S1 to S4 during the operation of the vehicle 1, the process of step S1˜S4 at the beginning of operation of the vehicle 1 for a predetermined period of time, or repeatedly executed by a predetermined distance, then it may be used optimized intervention quantity. Further, the driver is specified by the camera of the sensor unit 14, and the intervention amount optimized for the driver is stored in the storage unit 13, may be used during the next and subsequent operations. After optimizing the intervention amount of the driving assistance function, it is displayed on the display unit 15 whether the intervention amount is appropriate, when the operation input indicating that the intervention amount is not appropriate by the driver is performed, the intervention amount is reset from the beginning the process of optimizing the intervention amount it may be re-performed.

In addition, if the driver is presumed to be distracting when the intervention amount of the driving assistance function is increased, the intervention amount may be maintained for a certain period of time, and if the distraction is encountered, S1˜S4 of steps may be restarted, and if the distraction is not encountered, the intervention amount may be reduced.

The control amount determining section 112 may determine the steering amount of the steering wheel, the intervention amount to assist the operation amount of the accelerator or the brake in accordance with the emotion of the driver. Specifically, when the emotion estimation unit 111 estimates that the emotion of the driver is comfortable, the control amount determination unit 112 determines to increase the steering amount of the steering wheel, the intervention amount assisting the operation amount of the accelerator or the brake. On the other hand, when the emotion estimation unit 111 estimates that the emotion of the driver is uncomfortable, the control amount determination unit 112 determines to reduce the amount of intervention that assists in steering, accelerating, or braking of the steering wheel. As a result, the amount of intervention to assist the steering amount of the steering wheel, the accelerator, or the brake operation amount can be brought close to a value that the driver feels more comfortable.

The emotion estimation unit 111 may estimate whether or not the driver feels drowsy. Driver drowsiness can be determined by counting the number of blinks of the driver using the imaging signal captured by the camera of the sensor unit 14. Further, the sleepiness of the driver may be determined by CO2 density of the exhaled breath of the driver measured by CO2 sensor of the sensor unit 14

When the emotion estimation unit 112 estimates that the driver feels drowsy, the control amount determination unit 112 reduces the intervention amount of the driving assist function. As a result, even if the driver's emotion is comfortable, the driver's drowsiness can be reduced by reducing the intervention amount of the driving assistance function when the driver feels drowsiness.

The emotion estimation unit 111 may estimate whether the driver is inoperable or unsuitable. It is possible to determine whether or not the driver is inoperable by the heart rate of the driver that the communication unit 12 acquired from the wearable terminal. Further, using the imaging signal captured by the camera of the sensor unit 14, when the driver is sneezing or gazing at the car navigation, it can be determined that the driver is in an ill-posed state for driving. When the emotion estimation unit 111 estimates that the driver cannot operate or is unsuitable, the control amount determination unit 112 increases the intervention amount of the driving assist function. As a result, when the driver is inoperable or unsuitable, the degree of assisting the driver's operation can be increased by the driving assistance function.

In addition, the intervention amount of the driving assistance function may be determined according to the situation when the vehicle 1 is traveling. Specifically, when the vehicle 1 is traveling on a highway or a vehicle-only road, the control amount determination unit 112 may determine to increase the intervention amount of the driving assistance function. In addition, when the visibility of the road surface is difficult due to dense fog or rain at night, or the like, when the visibility of the surrounding is difficult due to the morning sun or the evening sun, the control amount determination unit 112 may determine to increase the intervention amount of the driving assist function.

Further effects and variations can be readily derived by one skilled in the art. Thus, the broader aspects of the present disclosure are not limited to the particular details and representative embodiments described and represented above.

Accordingly, various modifications are possible without departing from the spirit or scope of the overall concept defined by the appended claims and their equivalents.

According to the present disclosure, it is possible to realize a vehicle control device capable of adjusting an intervention amount of the driving assistance function to a value suitable for the driver.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle controller comprising:
a processer configured to
estimate emotion of a driver based on biological information thereof; and
determine an intervention amount of a driving assistance function based on the estimation result.

2. The vehicle controller according to claim 1, wherein
the processor is configured to
estimate whether the emotion of the driver is comfortable based on the biological information, and
increase the intervention amount of the driving assistance function when estimating that the emotion of the driver is comfortable.

3. The vehicle controller according to claim 1, wherein the processor is configured to
estimate whether the driver feels sleepy based on the biological information, and
decrease the intervention amount of the driving assistance function when estimating that the driver feels sleepy.

4. The vehicle controller according to claim 1, wherein the processor is configured to
estimate whether the driver is unable or inappropriate to drive, and
increase the intervention amount of the driving assistance function when estimating that the driver is unable or inappropriate to drive.
